(19) United States
(12) Patent Application Publication
(10) Pub. No.: US 2026/0363483 A1
(43) Pub. Date: Nov. 19, 2026

(54) POT LID ASSEMBLY AND COOKING APPLIANCE

(71) Applicant: FOSHAN SHUNDE MIDEA ELECTRICAL HEATING APPLIANCES MANUFACTURING CO., LTD., Foshan (CN)

(72) Inventors: Ce ZHAO, Foshan (CN); Xiaoyong JIANG, Foshan (CN); Yuquan WU, Foshan (CN); Yi ZHOU, Foshan (CN); Jinwang SHENG, Foshan (CN); Jiakong LI, Foshan (CN)

(21) Appl. No.: 19/126,378

(22) PCT Filed: Mar. 23, 2023
(86) PCT No.: PCT/CN2023/083472

§ 371 Date: May 1, 2025

(30) Foreign Application Priority Data
Nov. 11, 2022 (CN) 202223011808.9

(51) Int. Cl. A47J 36/06; A47J 36/02

(52) U.S. Cl. CPC A47J 36/06; A47J 36/02; A47J 2202/00

(57) ABSTRACT

A pot lid assembly includes an inner lid having a mounting space, a coil assembly fixed in the mounting space and including a coil winding, a thermal insulation base plate disposed on the inner lid and located below the coil assembly, a thermochromic coating disposed on a surface of the thermal insulation base plate and configured to change color subsequent to a temperature of the thermochromic coating reaching a color changing temperature, and a thermal insulation cover plate disposed at a side of the inner lid facing towards a pot and located below the thermal insulation base plate. The thermal insulation cover plate is heated when the coil winding is energized.

### PRIORITY INFORMATION

This application claims priority to and benefit of Chinese Patent Application No. 202223011808.9, filed with China National Intellectual Property Administration on Nov. 11, 2022, the entire disclosure of which is incorporated herein by reference.

### FIELD

The present disclosure belongs to the field of household electrical appliances, and in particular, relates to a pot lid assembly and a cooking appliance.

### BACKGROUND

For existing cooking appliances, taking a rice cooker as an example, during cooking or thermal insulation, a temperature of a lid, especially an inner surface of the lid will rise simultaneously. When the lid is opened, there is a scalding risk if one touches the inner surface of the lid without knowing a temperature of the inner surface of the lid. With the continuous improvement of people's requirements for safety and use convenience of the cooking appliance, how to reduce the scalding risk of the cooking appliance remains to be further studied.

### SUMMARY

The present disclosure aims to at least solve one of the technical problems in the related art to some extent. To this end, an objective of the present disclosure is to provide a pot lid assembly and a cooking appliance, to utilize a color change of a thermochromic coating as a temperature warning to remind a user whether a temperature of a thermal insulation cover plate is within a safe temperature range, which reduces a scalding risk when performing operations such as cleaning the thermal insulation cover plate.

In an aspect of the present disclosure, the present disclosure provides a pot lid assembly. According to embodiments of the present disclosure, the pot lid assembly includes an inner lid, a coil assembly, a thermal insulation base plate, a thermochromic coating, and a thermal insulation cover plate. The inner lid has a mounting space. The coil assembly is fixed in the mounting space and includes a coil winding. The thermal insulation base plate is disposed on the inner lid and located below the coil assembly. The thermochromic coating is disposed on a surface of the thermal insulation base plate and adapted to change color subsequent to a temperature of the thermochromic coating reaching a color changing temperature. The thermal insulation cover plate is disposed at a side of the inner lid facing towards a pot and located below the thermal insulation base plate. The thermal insulation cover plate is heated when the coil winding is energized.

Compared with the related art, on the one hand, this pot lid assembly may utilize the coil assembly to heat the thermal insulation cover plate, efficiently heat food through the thermal insulation cover plate, and fully stimulate the Maillard reaction to achieve a better cooking effect. On the other hand, a temperature of the thermal insulation base plate between the thermal insulation cover plate and the coil assembly may indirectly evaluate a temperature of the thermal insulation cover plate. The color change of the thermochromic coating may be used as the temperature warning to remind the user whether the temperature of the thermal insulation cover plate is within the safe temperature range, which reduces the scalding risk when performing operations such as cleaning the thermal insulation cover plate.

In addition, the pot lid assembly according to the above embodiments of the present disclosure may also have the following additional technical characteristics.

In some embodiments, the coil assembly is configured to heat the thermal insulation cover plate by generating an eddy current that passes through the thermal insulation base plate.

In some embodiments, the thermal insulation cover plate includes a metal plate. The metal plate generates heat by cutting through the eddy current generated by the coil winding when the coil winding is energized.

In some embodiments, the thermal insulation cover plate further includes a connection member. The metal plate is detachably connected to the inner lid through the connection member.

In some embodiments, a surface of the thermochromic coating is covered with a first hydrophobic layer made of a transparent material.

In some embodiments, a thickness of the first hydrophobic layer is smaller than or equal to 0.1 mm.

In some embodiments, the pot lid assembly further includes a surface coating disposed on the thermal insulation base plate and located at a side of the thermochromic coating away from the pot.

In some embodiments, the thermal insulation base plate is a transparent base plate, the thermochromic coating is disposed on a surface of the thermal insulation base plate away from the pot, and the surface coating is disposed on a surface of the thermochromic coating away from the pot; and/or a thickness of the surface coating is smaller than or equal to 0.1 mm.

In some embodiments, the surface coating is a wear-resistant and scratch-resistant coating.

In some embodiments, a side of the surface coating away from the pot is covered with a second hydrophobic layer.

In some embodiments, a thickness of the second hydrophobic layer is smaller than or equal to 0.1 mm.

In some embodiments, a color saturation of the thermochromic coating changes reversibly with a temperature change.

In some embodiments, at least part of the thermochromic coating is a reversible color changing region. The reversible color changing region is a temperature-sensitive color-developing region, a temperature-sensitive color-disappearing region, or an interval temperature-sensitive color-developing region.

In some embodiments, the thermochromic coating includes a plurality of color changing sub-coatings that are arranged at intervals or continuously. Color changing temperatures of the plurality of color changing sub-coatings are the same or different.

In some embodiments, the thermochromic coating includes thermochromic ink.

In some embodiments, the color changing temperature of the thermochromic coating ranges from 5 °C to 80 °C.

In some embodiments, a thickness of the thermochromic coating is smaller than or equal to 0.1 mm.

In some embodiments, a region of the thermal insulation base plate in direct contact with the thermochromic coating is a rough surface. The rough surface is formed by roughening the surface of the thermal insulation base plate.

In some embodiments, roughness Ra of the rough surface is greater than or equal to 0.1 μm.

In some embodiments, the thermal insulation base plate is an inorganic glass base plate, a microcrystalline glass base plate, or a transparent resin base plate; and/or a thickness of the thermal insulation base plate ranges from 2 mm to 5 mm.

In some embodiments, in a thickness direction of the inner lid, a distance between the thermal insulation base plate and the coil winding ranges from 5 mm to 30 mm, and/or a distance between the thermal insulation base plate and the thermal insulation cover plate ranges from 5 mm to 30 mm.

In some embodiments, the pot lid assembly further includes a steam valve disposed on the inner lid and located at a side of the mounting space. The thermal insulation base plate is disposed in the mounting space and located close to the steam valve; an enclosed space is formed by the coil assembly, the thermal insulation cover plate, and the steam valve, the thermal insulation base plate being disposed in the enclosed space; a distance between the thermal insulation base plate and the thermal insulation cover plate is smaller than or equal to a distance between the thermal insulation base plate and the coil winding; and/or the thermal insulation base plate is brown.

In some embodiments, the mounting space has a first inner wall formed into an arc shape and a second inner wall formed as a flat surface. The second inner wall is connected to both ends of the first inner wall, the second inner wall is disposed adjacent to the steam valve, and an outer peripheral wall of the coil assembly is adapted to a shape of the mounting space.

In some embodiments, a surface of the thermal insulation cover plate facing towards the pot has a concave-convex pattern. An orthogonal projection of the coil winding on the thermal insulation cover plate covers the concave-convex pattern.

According to another aspect of the present disclosure, the present disclosure provides a cooking appliance. According to the embodiments of the present disclosure, the cooking appliance includes the pot lid assembly as described above. The characteristics and effects described for the above-mentioned pot lid assembly also apply to this cooking appliance, and details are omitted here. Compared with the related art, this cooking appliance not only has a simple structure, but also has higher safety. The user may be reminded to pay attention to the scalding risk when performing operations such as cleaning a lid based on the color change of the thermochromic coating, providing a better user experience.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a front view of a pot lid assembly according to an embodiment of the present disclosure.

FIG. 2 is a top view of a pot lid assembly according to an embodiment of the present disclosure.

FIG. 3 is a partially exploded structural view of a pot lid assembly according to an embodiment of the present disclosure.

FIG. 4 is a schematic structural view of a thermochromic coating and a surface coating according to an embodiment of the present disclosure.

FIG. 5 is a schematic structural view of a thermochromic coating and a surface coating according to another embodiment of the present disclosure.

FIG. 6 is a schematic exploded structural view of a pot lid assembly according to another embodiment of the present disclosure.

### REFERENCE NUMERALS

10-inner lid; 11-mounting space; 11a-first inner wall; 11b-second inner wall; 12-steam valve; 20-coil assembly; 21-coil winding; 22-coil support; 23-temperature sensor; 30-thermal insulation base plate; 31-temperature-sensor avoidance hole; 40-thermochromic coating; 41-color changing sub-coating; 50-thermal insulation cover plate; 51-metal plate; 52-connection member; 53-concave-convex pattern; 54-detection hole; 60-surface coating; 70-surface cover assembly; 71-display panel; 80-magnetic isolation sheet.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it needs to be understood that, orientation or position relationship indicated by terms such as “center,” “width,” “thickness,” “over,” “below,” “top,” “bottom,” “in,” “out,” and “circumferential” is based on the orientation or position relationship shown in the accompanying drawings, and is merely for the convenience of describing the present disclosure and simplifying the description, rather than indicating or implying that the associated device or element must have a specific orientation, or be constructed and operated in a specific orientation, and therefore cannot be understood as a limitation on the present disclosure. In the description of the present disclosure, “plurality of” means at least two, such as two, three, etc., unless otherwise specifically defined. In the present disclosure, unless otherwise clearly specified and limited, terms such as “install,” “connect,” “connect to,” “fix” and the like should be understood in a broad sense. For example, unless otherwise clearly limited, it may be a fixed connection or a detachable connection or connection as one piece; mechanical connection or electrical connection; direct connection or indirect connection through an intermediate; internal communication of two components or the interaction relationship between two components. For those skilled in the art, the specific meaning of the above-mentioned terms in the present disclosure can be understood according to specific circumstances. In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

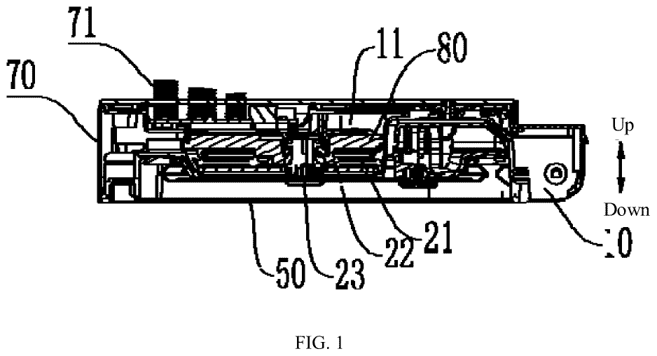

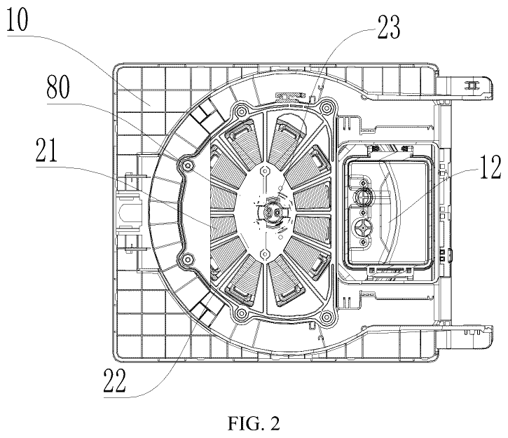

In an aspect of the present disclosure, the present disclosure provides a pot lid assembly. According to the embodiments of the present disclosure, referring to FIG. 1 to FIG. 6 for understanding, the pot lid assembly includes an inner lid 10, a coil assembly 20, a thermal insulation base plate 30, a thermochromic coating 40, and a thermal insulation cover plate 50. The inner lid 10 has a mounting space 11. The coil assembly 20 is fixed in the mounting space 11 and includes a coil winding 21. The thermal insulation base plate 30 is disposed on the inner lid 10 and located below the coil assembly 20. The thermochromic coating 40 is disposed on a surface of the thermal insulation base plate 30 and adapted to change color subsequent to a temperature of the thermochromic coating 40 reaching a color changing temperature. The thermal insulation cover plate 50 is disposed at a side of the inner lid 10 facing towards the pot and located below the thermal insulation base plate 30. The thermal insulation cover plate 50 is heated when the coil winding 21 is energized. The thermal insulation cover plate 50 is configured to be detachably connected to the inner lid. Compared with the related art, on the one hand, this pot lid assembly may utilize the coil assembly to heat the thermal insulation cover plate, efficiently heat food through the thermal insulation cover plate, and fully stimulate the Maillard reaction to achieve a better cooking effect. On the other hand, a temperature of the thermal insulation base plate between the thermal insulation cover plate and the coil assembly may indirectly evaluate a temperature of the thermal insulation cover plate. A color change of the thermochromic coating may be used as a temperature warning to remind a user whether the temperature of the thermal insulation cover plate is within a safe temperature range, which reduces a scalding risk when performing operations such as cleaning the thermal insulation cover plate. It needs to be noted that this pot lid assembly may be either a part of a pot lid or a complete pot lid. In addition, it can be understood that the thermochromic coating described in the present disclosure is a reversible thermochromic coating.

The following provides a detailed description of the pot lid assembly according to the above-mentioned embodiments of the present disclosure with reference to FIG. 1 to FIG. 6.

According to the embodiments of the present disclosure, a traditional cooking appliance is usually integrated with a heating device on a lid thereof to make the food heated three-dimensionally, enabling an upper part of the food also to be heated evenly, fully stimulating the Maillard reaction, and making the food more flavorful. In the present disclosure, a coil is provided on the lid, and a magnetic force generated when a current flows to the coil is used to heat the thermal insulation cover plate, making the thermal insulation cover plate heated up, indirectly realizing heating of the food. Therefore, the cooking appliance can obtain sufficient thermal power, making a cooking effect of the cooking appliance on the food better. Since the thermal insulation cover plate is in direct contact with steam or food in a pot, after heating or thermal insulation is completed, the thermal insulation cover plate usually needs to be cleaned. At this time, when the temperature of the thermal insulation cover plate is high, it is easy to cause scalding. By providing the thermochromic coating on a thermal insulation base plate disposed in a temperature field between the coil assembly and the thermal insulation cover plate, a characteristic where the thermochromic coating changes color after reaching the color changing temperature and the color change is reversible may be used as the temperature warning to remind the user whether the temperature of the thermal insulation cover plate is within the safe temperature range, reducing the scalding risk. For example, materials such as color changing ink with a fixed and obvious color at a normal temperature and an obvious color change when reaching a predetermined temperature (such as 45 °C and the like) may be used to form the thermochromic coating, to remind the user whether there is a scalding risk at a current temperature of the thermal insulation cover plate. Therefore, during cooking, the coil assembly can be used to heat the thermal insulation cover plate. During temperature rising of the thermal insulation cover plate, a thermochromic coating located in the temperature field between the thermal insulation cover plate and the coil assembly is also heated up. When the predetermined temperature is exceeded, the thermochromic coating changes color. After the heating or thermal insulation is completed, when the thermal insulation cover plate needs to be cleaned, the thermal insulation cover plate may be removed to observe a color of the thermochromic coating. When the color of the thermochromic coating is still a color shown when there is a scalding risk, it means that the thermal insulation cover plate is not cooled sufficiently, and there is still a scalding risk when touched. When the color of the thermochromic coating returns to an initial color or shows other safe colors, it means that the thermal insulation cover plate is cooled to within the safe temperature range, and there is no scalding risk for a further operation. That is, in the pot lid assembly of the present disclosure, alternating electromagnetic generated by the coil assembly 20 passes through the thermal insulation base plate 30 to heat the thermal insulation cover plate 50. As the temperature of the thermal insulation cover plate rises, the temperature field is formed between the coil assembly and the thermal insulation cover plate, which makes the temperature of the thermal insulation base plate rise, causing the thermochromic coating on the surface of the thermal insulation base plate to change color. When the heating stops, the temperature of the thermal insulation cover plate gradually decreases, and the temperatures of the thermal insulation base plate and the thermochromic coating also gradually decrease. The color change of the thermochromic coating is reversible. The thermochromic coating changes color when the temperature of the thermochromic coating rises to the color changing temperature and returns to its original color when the temperature of the thermochromic coating drops to the color changing temperature. Therefore, providing the thermochromic coating on the thermal insulation base plate can better reflect a temperature between the thermal insulation cover plate and the coil assembly, reducing the scalding risk.

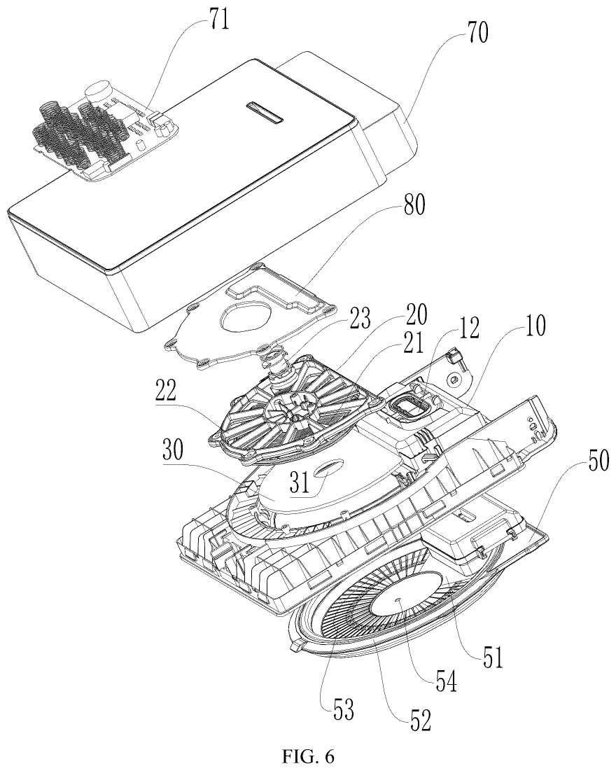

According to the embodiments of the present disclosure, referring to FIG. 6 for understanding, the thermal insulation cover plate 50 may include a metal plate 51. When the coil winding 21 is energized, the metal plate 51 generates heat by cutting through an eddy current generated by the coil winding 21. By using this manner, electromagnetic heating may be directly achieved by utilizing a body structure of the thermal insulation cover plate, without the need to provide other metal parts to cut through the eddy current generated by the coil winding for generating heat and then perform indirect heating or radiation heating on the thermal insulation cover plate. Therefore, not only can heating efficiency of the lid assembly be made higher, but a lid structure can also be simplified, making an integration degree of the lid higher and an overall volume of the lid smaller.

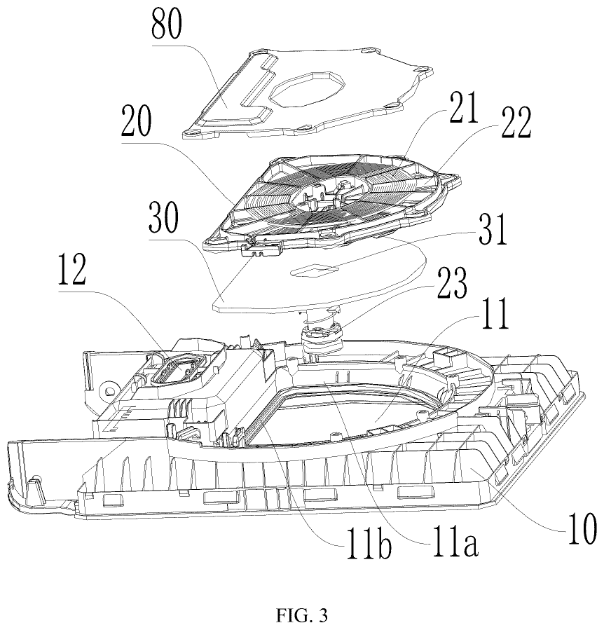

According to the embodiments of the present disclosure, referring to FIG. 3 and FIG. 6 for understanding, the thermal insulation cover plate 50 further includes a connection member 52. The metal plate 51 is detachably connected to the inner lid 10 through the connection member 52. An edge of the connection member may be adapted to a shape of an edge of the inner lid and may cover a side of the mounting space 11 facing towards the pot. In addition, the connection member 52 may be at least partially made of a thermal insulation material or may be at least partially provided with a thermal insulation component. Therefore, it is possible to avoid a scalding risk that may be caused by a too high temperature of the metal plate when a high-temperature cover plate is removed.

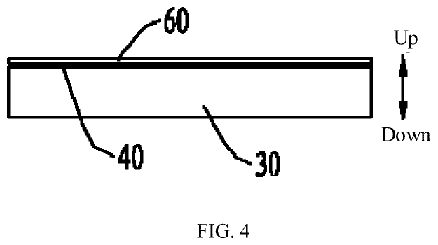

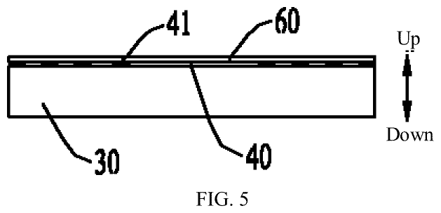

According to the embodiments of the present disclosure, it needs to be noted that the thermochromic coating 40 is disposed in a visible region of the thermal insulation base plate 30. That is, regardless of whether the thermochromic coating 40 is located at a surface of the thermal insulation base plate 30 close to the pot or a surface of the thermal insulation base plate 30 away from the pot, when the thermal insulation cover plate is removed, the color change of the thermochromic coating 40 is visible. In addition, the thermochromic coating 40 may be disposed on at least a part of the surface of the thermal insulation base plate 30 facing towards the pot (here, the pot refers to containers such as an inner pot for accommodating food to be cooked). The thermochromic coating 40 may also be disposed on at least a part of the surface of the thermal insulation base plate 30 away from the pot (referring to FIG. 4 or FIG. 5 for understanding), and at this time, the thermal insulation base plate is preferably made of a transparent material. Alternatively, the thermochromic coating 40 may be simultaneously disposed on at least a part of the surface of the thermal insulation base plate 30 facing towards the pot and at least a part of the surface of the thermal insulation base plate 30 away from the pot. The above three arrangement manners may each achieve visibility and stability of the color change of the thermochromic coating.

According to the embodiments of the present disclosure, referring to FIG. 4 or FIG. 5, an orthogonal projection of the thermochromic coating 40 on the thermal insulation base plate 30 may be located within a region where the thermal insulation base plate 30 is located. Therefore, the visibility of the thermochromic coating can be further ensured.

According to the embodiments of the present disclosure, when the thermochromic coating 40 is exposed on the surface of the thermal insulation base plate 30, a surface of the thermochromic coating 40 away from the thermal insulation base plate 30 may also be covered with a first hydrophobic layer (not shown). Moreover, at this time, the first hydrophobic layer may be made of a transparent material. By using a transparent hydrophobic layer, on the one hand, the visibility of the color change of the thermochromic coating is not affected. On the other hand, it is also possible to provide a certain protection for the thermochromic coating, not only to avoid volatilization and escape of a color changing pigment and the like in the thermochromic coating during the cooking, but also to reduce a negative impact of water vapor that may exist between the thermal insulation cover plate and the coil assembly on the thermochromic coating during the cooking, while to avoid scratching and abrasion that may occur to the thermochromic coating during actual operations (such as cleaning, mounting, or disassembly), ensuring a protection effect on the thermochromic coating and use stability of the thermochromic coating. Further, a thickness of the hydrophobic layer may be smaller than or equal to 0.1 mm. For example, the thickness of the hydrophobic layer may be 0.02 mm, 0.04 mm, 0.06 mm, 0.08 mm, or 0.09 mm. Therefore, while the hydrophobic effect is achieved, a negative impact, which may be caused by an excessive thickness of the hydrophobic layer, on an overall structure of the pot lid is avoided. Further, when the surface of the thermochromic coating 40 is covered with the first hydrophobic layer, a projection of the thermochromic coating 40 on the first hydrophobic layer may be located within a region where the first hydrophobic layer is located and is smaller than the first hydrophobic layer in area. Therefore, a hydrophobic protection effect of the first hydrophobic layer on the thermochromic coating can be further ensured. In addition, when the first hydrophobic layer is provided, a type of the first hydrophobic layer is not particularly limited, and may be flexibly selected by those skilled in the art as actual needs. For example, the first hydrophobic layer may be either a hard layer, such as a hydrophobic layer with inorganic glass or hard plastics (such as polymethyl methacrylate and polycarbonate) as matrix, or a flexible film layer, such as a hydrophobic layer with polyethylene and the like as matrix.

According to the embodiments of the present disclosure, referring to FIG. 4 or FIG. 5 for understanding, the pot lid assembly may also include a surface coating 60 disposed on the thermal insulation base plate 30 and located at a side of the thermochromic coating 40 away from the pot. The surface coating may be provided according to actual needs to improve a wear-resistant and scratch-resistant effect or a color-rendering effect of the thermochromic coating. For example, the surface coating may be set to have a specific color (such as white or black) and may be used to reduce a visual interference of a background color on the color change of the thermochromic coating, making the color change of the thermochromic coating more obvious. It needs to be noted that, on the basis of achieving an expected effect, the color of the surface coating 60 is not particularly limited, and may be flexibly selected by those skilled in the art as actual needs. For example, the surface coating 60 may be black or white.

According to the embodiments of the present disclosure, when the thermal insulation base plate 30 is a transparent base plate, the thermochromic coating 40 may be disposed on the surface of the thermal insulation base plate 30 away from the pot. At this time, the surface coating 60 may be disposed on a surface of the thermochromic coating 30 away from the pot (referring to FIG. 4 or FIG. 5 for understanding). Therefore, the surface coating can be allowed to have the wear-resistant and scratch-resistant effect or other expected effects without adversely affecting the color-rendering effect of the thermochromic coating. For example, according to a specific example of the present disclosure, at this time, the surface coating 60 may be a wear-resistant and scratch-resistant coating. Therefore, wear-resistant and scratch-resistant performance of the thermochromic coating can not only be improved, to avoid the scratching or abrasion that may occur during the actual operations (such as cleaning, mounting, or disassembly), but a certain protection effect can also be provided for the stability of the thermochromic coating, which not only prevents the volatilization and escape of the color changing pigment in the thermochromic coating during the cooking, but also reduces the negative impact of the water vapor that may exist between the thermal insulation cover plate and the coil assembly on the thermochromic coating during the cooking.

According to the embodiments of the present disclosure, referring to FIG. 4 or FIG. 5 for understanding, the thickness of the surface coating 60 may be smaller than or equal to 0.1 mm. For example, the thickness of the surface coating 60 may be 0.01 mm, 0.03 mm, 0.05 mm, 0.07 mm, or 0.09 mm. When the thickness of the surface coating is too large, connection difficulty and an adhesion force between the surface coating and the thermochromic coating may also be increased, affecting structural stability and use stability of the coating. Further, the thickness of the surface coating 60 may also be greater than or equal to 0.01 mm. When the thickness of this surface coating 60 is too small, it is difficult to achieve an effective expected effect. For example, an insufficient wear-resistant and scratch-resistant ability and/or an insufficient ability to cover the background color may be caused. By controlling the thickness of the surface coating within the above-mentioned range, a better expected effect may be achieved on the basis of ensuring operation difficulty and an adhesive strength.

According to the embodiments of the present disclosure, when the surface coating 60 is exposed on the surface of the thermochromic coating 40 away from the pot, the surface of the surface coating 60 away from the pot may also be covered with a second hydrophobic layer (not shown). By providing the second hydrophobic layer, the negative impact of the water vapor that may exist between the thermal insulation cover plate and the coil assembly on the thermochromic coating during the cooking can not only be reduced, but a certain protection effect is also provided for the surface coating, avoiding the scratching and abrasion that may occur to the surface coating during the actual operations and ensuring the protection effect on the surface coating and the use stability of the surface coating. Further, the thickness of the second hydrophobic layer may be smaller than or equal to 0.1 mm. For example, the thickness of the second hydrophobic layer may be 0.02 mm, 0.04 mm, 0.06 mm, 0.08 mm, or 0.09 mm. Therefore, while the hydrophobic effect is achieved, the negative impact, which may be caused by the excessive thickness of the hydrophobic layer, on the overall structure of the pot lid is avoided. Further, when the surface of the surface coating 60 is covered with the second hydrophobic layer, a projection of the surface coating 60 on the second hydrophobic layer may be located within a region where the second hydrophobic layer is located and is smaller than the second hydrophobic layer in area. Therefore, a hydrophobic protection effect of the second hydrophobic layer on the surface coating can be further ensured. In addition, when the second hydrophobic layer is provided, a type of the second hydrophobic layer is not particularly limited, and may be flexibly selected by those skilled in the art as actual needs. For example, the second hydrophobic layer may be either a hard layer, such as a hydrophobic layer with inorganic glass or hard plastics (such as polymethyl methacrylate and polycarbonate) as matrix, or a flexible film layer, such as a hydrophobic layer with polyethylene and the like as matrix.

According to the embodiments of the present disclosure, it can be understood that when the thermochromic coating 40 is in direct contact with the thermal insulation base plate 30 or the surface coating 60, a connection between the thermochromic coating 40 and the thermal insulation base plate 30 or the surface coating 60 may be achieved by adding an adhesive to the coating or by separately providing an adhesive layer. Correspondingly, direct or indirect contact between the thermochromic coating 40 and the first hydrophobic layer, as well as between the surface coating 60 and the second hydrophobic layer, may also be achieved through the adhesive in the coating or an adhesive layer separately provided. There is no strict limitation in the present disclosure, and those skilled in the art may flexibly choose as actual needs.

According to the embodiments of the present disclosure, the thermochromic coating 40 may include a color changing pigment and an adhesive material. Further, the thermochromic coating 40 may also include a filling material. Therefore, a color changing function can be provided for the thermochromic coating by using the color changing pigment. The adhesive material may be either an adhesive or an adhesive layer. When the adhesive is used, the color changing pigment (and an optional filling material) may be mixed with the adhesive to form an adhesive slurry, and the thermochromic coating may be formed by manners such as coating and printing. When the adhesive layer is selected for use, the color changing pigment may be directly fixed on the surface of the thermal insulation base plate by the adhesive layer to achieve position-limiting and fixation of the color changing pigment. At this time, an orthogonal projection of the thermochromic coating on the adhesive layer should be located within a region defined by the adhesive layer, and a spacing may be existed between an edge of the thermochromic coating and an edge of the adhesive layer.

In addition, it needs to be noted that a type of the color changing pigment in the present disclosure is not particularly limited, and may be flexibly selected from existing color changing pigments by those skilled in the art as actual needs. For example, the color changing pigment may be thermochromic ink, i.e., the thermochromic coating 40 may include thermochromic ink. In addition, a color changing mechanism of this color changing pigment/ink is that when the temperature changes, a region with the color changing pigment/ink (such as graphic and text information) can exhibit different color effects at different temperatures. For example, the color changing pigment/ink may have a fixed and obvious color at the normal temperature and may change color to show another color when a predetermined temperature or above is reached. When the temperature returns to be normal, the color changing pigment/ink also returns to its original color. Preferably, the color changing pigment/ink may be allowed to have a fixed and obvious color at the normal temperature, change color rapidly and have an obvious color changing boundary when the predetermined temperature is reached. Moreover, the color changing pigment/ink has a large color difference before and after the color change, is less affected by an external environment, and has stable performance under high-temperature (such as 130 °C), light, humid, and other atmospheric environments, without decomposition or color fading.

According to the embodiments of the present disclosure, a specific setting shape of the thermochromic coating 40 is not particularly limited, and may be flexibly selected by those skilled in the art as actual needs. For example, the shape of the thermochromic coating 40 may be a regular or irregular graphic structure (such as an annular band, an annular ring, a plurality of concentric annular rings that are arranged at intervals, an exclamation mark, and a flame-shaped graphic), a text structure (such as Chinese characters or foreign languages of high temperature, hot, attention), or a composite structure of graphics and text.

According to the embodiments of the present disclosure, a formation manner of the thermochromic coating 40 is also not particularly limited, and may be flexibly selected by those skilled in the art as actual needs. For example, the thermochromic coating 40 may be formed by manners such as coating, printing, or transfer printing. Preferably, a thermal stability temperature of the thermochromic coating 40 may be higher than or equal to 130 °C. Therefore, the thermochromic coating 40 may withstand a high temperature during the cooking of the pot without volatilization or decomposition.

According to the embodiments of the present disclosure, a color saturation of the thermochromic coating 40 changes reversibly with a temperature change. For example, through selection from existing color changing pigments/inks, the higher the temperature, the darker the color shown by the thermochromic coating. Therefore, the user can more intuitively obtain the degree of temperature change by combining an overall color change and the change in color saturation, which can achieve a better temperature warning effect and prevent scalding.

According to the embodiments of the present disclosure, at least part of the thermochromic coating 40 is a reversible color changing region. It can be understood that the thermochromic coating 40 may be either entirely the reversible color changing region or partially the reversible color changing region. For example, the thermochromic coating 40 may include a reversible color changing region and a fixed-color region. When the color changing temperature is not reached, the reversible color changing region and the fixed-color region may show the same color. When the reversible color changing region reaches the color changing temperature, the fixed-color region remains unchanged, and the reversible color changing region occurs the color change to form an expected graphic or text in the fixed-color region. Further, the reversible color changing region may be a temperature-sensitive color-developing region, a temperature-sensitive color-disappearing region, or an interval temperature-sensitive color-developing region. The temperature-sensitive color-developing region refers to a region where the reversible color changing region is colorless at a temperature lower than the color changing temperature, shows a specific color after the temperature rises to the color changing temperature (a specific displayed color and the color changing temperature depend on an actually-selected color changing pigment), and may be re-shown to be colorless after the temperature drops. For example, the temperature-sensitive color-developing region may be shown in a colorless state below 45 °C, may show a specific color after the temperature rises to 45 °C, and may be re-shown to be colorless after the temperature drops below 45 °C. The temperature-sensitive color-disappearing region refers to a region where the reversible color changing region shows a fixed color at a temperature lower than the color changing temperature (the specific displayed color and the color changing temperature depend on the actually-selected color changing pigment), the color disappears after the temperature rises to the color changing temperature, and re-shows the original color after the temperature drops. For example, the temperature-sensitive color-disappearing region may show a fixed color below 45 °C, the original color disappears and become colorless after the temperature rises to 45 °C, and may re-show the original color after the temperature drops below 45 °C. The interval temperature-sensitive color-developing region refers to a region where the reversible color changing region may be shown in a colorless state both below and above the color changing temperature, and only shows a specific color within a predetermined temperature interval (the specific displayed color and a color changing temperature interval depend on the actually-selected color changing pigment). For example, the interval temperature-sensitive color-developing region may show color within an interval ranging from 33 °C to 47 °C and be shown in a colorless state below 33 °C or above 47 °C. The above three types of reversible color changing regions may each achieve the color change of the thermochromic coating at the predetermined temperature, provide the temperature warning for the user, and reduce the scalding risk. Further, the reversible color changing region may be the temperature-sensitive color-developing region or the temperature-sensitive color-disappearing region. For example, the reversible color changing region may be preferentially selected as the temperature-sensitive color-developing region, which can provide a more obvious color changing warning effect.

According to the embodiments of the present disclosure, referring to FIG. 5 for understanding, the thermochromic coating 40 may include a plurality of color changing sub-coatings 41 that are arranged at intervals or continuously. Color changing temperatures of the plurality of color changing sub-coatings 41 are the same or different. Intervals or continuous arrangement of the plurality of color changing sub-coatings 41 may be used to form a specific color changing pattern or text, or the different color changing temperatures of the plurality of color changing sub-coatings may be used to form a plurality of color changing warnings, which allows the thermochromic coating 40 to show different colors in different temperature intervals, enabling the user to more accurately estimate a temperature range of the thermal insulation cover plate of the pot according to different color changes. Each of the color changing sub-coatings 41 may independently have at least a part of the color changing sub-coatings 41 as the reversible color changing region, and the reversible color changing region may be selected as the temperature-sensitive color-developing region, the temperature-sensitive color-disappearing region, or the interval temperature-sensitive color-developing region. According to a specific example of the present disclosure, the plurality of color changing sub-coatings 41 may be arranged side by side or arranged in an annular shape around a center of the thermal insulation base plate 30, or may be a plurality of concentric circles or concentric rings that are arranged from the inside to the outside in a radial direction of the thermal insulation base plate 30 (referring to FIG. 5 for understanding). The “inside” refers to a direction close to the center of the thermal insulation base plate, and the “outside” refers to a direction away from the center of the thermal insulation base plate. As described above, the above three types of color changing sub-coatings may each achieve the color change of the thermochromic coating at the predetermined temperature, provide the user with the temperature warning, and reduce the scalding risk. Preferably, a reversible color changing region of at least one of the color changing sub-coatings 41 may be the temperature-sensitive color-developing region or the temperature-sensitive color-disappearing region, and more preferably, may be the temperature-sensitive color-developing region, which can provide a more obvious color changing warning effect.

According to the embodiments of the present disclosure, the color changing temperature of the thermochromic coating 40 may be controlled to an expected value through specific selection from the thermochromic pigments or inks. For example, the color changing temperature of the thermochromic coating 40 may be controlled to range from 5 °C to 80 °C, such as 40°C, 41 °C, 42 °C, 43 °C, 44 °C, or 45 °C. According to a specific example of the present disclosure, it may be preferred that the color changing temperature of the thermochromic coating 40 is made lower than or equal to 45 °C. More preferably, the color changing temperature may be controlled at 45 °C. Under normal circumstances, the human body may tolerate a temperature of 45 °C. However, when the temperature exceeds 45 °C, there will be an obvious scalding sensation. By controlling the color changing temperature within the above range, it is also possible to achieve a purpose of reminding the user to be careful of scalding through the color changing warning.

According to the embodiments of the present disclosure, referring to FIG. 4 or FIG. 5 for understanding, the thickness of the thermochromic coating 40 may be smaller than or equal to 0.1 mm. For example, the thickness of the thermochromic coating 40 may be 0.01 mm, 0.03 mm, 0.05 mm, 0.07 mm, or 0.09 mm. When the thickness of this thermochromic coating is too large, a connection strength and an adhesion force between this thermochromic coating and the thermal insulation base plate or the surface coating may be increased, affecting the structural stability and use stability of the thermochromic coating. Further, the thickness of the thermochromic coating 40 may also be greater than or equal to 0.005 mm. When the thickness of this thermochromic coating is too small, a problem that the color shown after the color changing temperature is reached is relatively light and the warning effect is not significant may be caused. By controlling the thickness of the thermochromic coating within the above-mentioned range, a significant color changing warning may be obtained on the basis of taking into account the adhesive strength.

According to the embodiments of the present disclosure, the thermal insulation base plate 30 may be made of a transparent material. Therefore, a better decorative effect can be achieved. For example, the thermal insulation base plate 30 may be an inorganic glass base plate, a microcrystalline glass base plate, or a transparent resin base plate. Therefore, it is not only conducive to ensuring transparency of the thermal insulation base plate but also enables the transparent base plate to have a predetermined strength to satisfy use requirements in practical operations. Further, the thickness of the thermal insulation base plate 30 may range from 2 mm to 5 mm. For example, the thickness of the thermal insulation base plate 30 may be 2.5 mm, 3 mm, 3.5 mm, 4 mm, or 4.5 mm. Therefore, an overall strength of the transparent base plate can be further ensured, making the transparent base plate have better use performance and safety performance.

According to the embodiments of the present disclosure, considering that there may be a problem of a weak adhesive strength between the thermal insulation base plate 30, such as an inorganic glass base plate, and the coating, a region of the thermal insulation base plate 30 in direct contact with the thermochromic coating 40 may be made a rough surface. The rough surface is formed by roughening the surface of the thermal insulation base plate. A type of roughening is not particularly limited. For example, the roughening may be achieved by pickling, plasma treatment, or grinding. Therefore, the adhesion force between the thermochromic coating and the surface of the thermal insulation base plate can be further improved, and structural stability and use stability of the thermal insulation base plate during use can be improved. Further, roughness Ra of the rough surface may be greater than or equal to 0.1 μm. For example, the roughness Ra of the rough surface may be greater than or equal to 0.2 μm, 0.5 μm, or 0.8 μm. Therefore, the adhesive strength between the thermal insulation base plate and the thermochromic coating can be further ensured.

According to the embodiments of the present disclosure, the thermal insulation cover plate 50 may have a hydrophobic surface at a side of the thermal insulation cover plate 50 facing towards the pot. This hydrophobic surface may achieve the hydrophobic purpose by using a hydrophobic property of the thermal insulation cover plate itself by means of changing a surface shape of the thermal insulation cover plate or adding a hydrophobic material to the thermal insulation cover plate, or achieve the hydrophobic purpose by forming a hydrophobic coating or attaching a hydrophobic film layer on the surface of the thermal insulation cover plate. Therefore, it is possible to further reduce a probability that the water vapor condenses and accumulates on the thermal insulation base plate, leading to the formation of white droplets from the food.

According to the embodiments of the present disclosure, the thermal insulation cover plate 50 may also have a heat reflection layer (not shown) disposed at the side of the thermal insulation cover plate 50 facing towards the pot. The heat reflection layer may be formed by the body structure of the thermal insulation cover plate or realized by an additional structural layer. By providing the heat reflection layer, a thermal insulation effect may be improved.

According to the embodiments of the present disclosure, referring to FIG. 6 for understanding, in a thickness direction of the inner lid 10, a distance between the thermal insulation base plate 30 and the coil winding 21 ranges from 5 mm to 30 mm. For example, the distance may be 10 mm, 15 mm, 20 mm, or 25 mm. A distance between the thermal insulation base plate 30 and the thermal insulation cover plate 50 ranges from 5 mm to 30 mm. For example, the distance may be 10 mm, 15 mm, 20 mm, or 25 mm. By using the above-mentioned settings, the temperatures of the thermal insulation base plate and the thermochromic coating may be made closer to the temperature of the thermal insulation cover plate, further improving sensitivity and reliability of the thermochromic coating in terms of temperature sensing and color changing.

According to the embodiments of the present disclosure, referring to FIG. 3 or FIG. 6 for understanding, the pot lid assembly may also include a steam valve 12. The steam valve 12 is disposed on the inner lid 10 and located at a side of the mounting space 11. The thermal insulation base plate 30 is disposed in the mounting space 11 and close to the steam valve 12. An enclosed space is formed by the coil assembly 20, the thermal insulation cover plate 50, and the steam valve 12. The thermal insulation base plate 30 is disposed in the enclosed space. A distance between the thermal insulation base plate 30 and the thermal insulation cover plate 50 is smaller than or equal to a distance between the thermal insulation base plate 30 and the coil winding 21. The thermal insulation base plate 30 is brown. Therefore, the enclosed space is formed by the coil assembly, the thermal insulation cover plate, and the steam valve, and the thermal insulation base plate is placed in this enclosed space, which enables the thermochromic coating on the thermal insulation base plate to better reflect an internal temperature of the lid. The thermal insulation base plate is closer to the thermal insulation cover plate, improving temperature-sensitive sensitivity of the thermochromic coating in reflecting the thermal insulation cover plate. In addition, the thermal insulation base plate 30 may also be set to be brown. The brown thermal insulation base plate has a better heat-absorption effect, and has better reliability when providing a high-temperature warning for a user. The brown thermal insulation base plate has a predetermined light transmittance. For example, the light transmittance may be greater than or equal to 40%, such as greater than or equal to 45%, greater than or equal to 50%, greater than or equal to 60%, greater than or equal to 70%, greater than or equal to 75%, or greater than or equal to 80%. The brown thermal insulation base plate may be made of inorganic glass or organic glass. For example, the brown thermal insulation base plate may be made of cranberry glass. In addition, after the thermochromic coating is formed on a surface of the brown thermal insulation base plate away from the pot, the surface coating may be further formed on the surface of the thermochromic coating away from the pot as actual needs, to achieve an expected purpose of improving the wear-resistant and scratch-resistant performance of the thermochromic coating.

In this embodiment, the steam valve 12 and the coil assembly 20 are disposed in a same horizontal plane. The steam valve 12 and the coil assembly 20 may be simultaneously integrated inside the lid assembly. Moreover, the steam valve 12 and the coil assembly 20 are arranged side by side without interfering with each other. Currently, when a coil is provided inside a lid of the cooking appliance, a steam valve of a rice cooker usually needs to be externally provided, which not only makes an overall structure of the lid complex and large in volume, but also results in a poor effect of the steam valve, affecting a cooking effect of the cooking appliance. In the present disclosure, by internally providing the steam valve in the inner lid, it is possible to make the effect of the steam valve better, an integration degree of the lid assembly higher, and an overall volume of the cooking appliance smaller.

According to the embodiments of the present disclosure, currently, a shape of the pot or the inner pot (not shown) is usually circular to make a heating effect of the cooking device uniform. Referring to FIG. 3 and FIG. 6 for understanding, since both the steam valve 12 and the coil assembly 20 are disposed above the pot or the inner pot, i.e., the steam valve 12 and the mounting space 11 in which the coil assembly 20 is mounted are both disposed at a part of the inner lid 10 corresponding to the pot or the inner pot. Moreover, because the steam valve 12 is disposed at a side of the inner lid 10 and above the pot or the inner pot, the steam valve 12 occupies a part of a circular portion of the inner lid 10 corresponding to the pot or the inner pot. In order to make the mounting space 11 larger in arrangement, the mounting space 11 is disposed on a part of the inner lid 10 corresponding to the pot or the inner pot except for a position of the steam valve 12 on the inner lid 10. Therefore, a shape of the mounting space 11 is formed into the shape of a large sector of a circle. Therefore, by providing the mounting space 11 to include a first inner wall 11a and a second inner wall 11b, the first inner wall 11a is formed into an arc shape, and the second inner wall 11b is formed as a flat surface. The second inner wall 11b is connected to both ends of the first inner wall 11a and is disposed adjacent to the steam valve 12. In this way, a setting area of the mounting space 11 can be made larger. Further, an arrangement area of the coil winding 21 of the coil assembly 20 in the mounting space 11 may be made larger. After the coil winding 21 is energized, more heat may be generated, which fully stimulates the Maillard reaction and makes the cooking effect of the cooking device better. It needs to be noted that the coil assembly 20 also includes a coil support 22 for fixing and supporting the coil winding. By making an outer peripheral wall of the coil assembly 20 be adapted to the shape of the mounting space 11, the coil support may be attached to the outer peripheral wall of the mounting space and have better arrangement stability, and the coil support may be placed in the entire mounting space, which not only ensures stability of an overall structure and a winding form of the coil winding to enable the coil winding to stably form a magnetic field to heat the thermal insulation cover plate, but also allows for a larger arrangement area of the coil winding within the mounting space. After the coil winding is energized, more heat may be generated, which fully stimulates the Maillard reaction, making the cooking effect of the cooking device better.

According to the embodiments of the present disclosure, referring to FIG. 6 for understanding, a surface of the thermal insulation cover plate 50 facing towards the pot has a concave-convex pattern 53. An orthogonal projection of the coil winding 21 on the thermal insulation cover plate 50 covers the concave-convex pattern 53. By using this manner, not only can a heating surface of the thermal insulation cover plate be increased by using the concave-convex pattern, but also the thermal insulation cover plate can obtain sufficient heat at the concave-convex pattern, to reduce condensed water at a bottom of the thermal insulation cover plate, avoiding the condensed water from dripping onto the food and affecting the taste of the food, and ensuring the cooking effect of the food.

According to the embodiments of the present disclosure, referring to FIG. 3 or FIG. 6 for understanding, the lid assembly of the cooking device also includes a temperature sensor 23. The temperature sensor 23 may be fixed on the coil support 22 and located in an inner ring space of the coil winding 21, which enables the temperature sensor to be disposed at a central position of the inner lid for detecting a temperature at the central position of the thermal insulation cover plate. At this time, the thermal insulation base plate 30 may have a temperature-sensor avoidance hole 31. Optionally, the thermal insulation cover plate 50 may also have a detection hole 54. The temperature sensor may abut against the detection hole 54 to detect the temperature of the thermal insulation cover plate and a steam temperature. Further, the temperature sensor may also be offset from a center of the coil winding 22 to simultaneously detect the temperature at the central position of the thermal insulation cover plate and the steam temperature and make full use of a winding space of the coil support.

According to the embodiments of the present disclosure, referring to FIG. 6 for understanding, the pot lid assembly may also include a surface cover assembly 70 and a magnetic isolation sheet 80. The surface cover assembly 70 may be located at an upper part of an overall structure of the lid assembly. The surface cover assembly 70 may also be provided with a display panel 71, allowing the user to control an operation state of the cooking device through the surface cover assembly. The surface cover assembly 70 is detachably connected to the inner lid 10. The magnetic isolation sheet 80 may be disposed between the surface cover and the coil assembly 20 to isolate radiation generated by the coil assembly, preventing the surface cover from being heated by the coil assembly, and ensuring operation stability of an electrical component integrated on the panel.

According to another aspect of the present disclosure, the present disclosure provides a cooking appliance. According to the embodiments of the present disclosure, the cooking appliance includes the pot lid assembly as described above. Compared with the related art, this cooking appliance not only has a simple structure, but also has high safety. The user may be reminded to pay attention to the scalding risk when performing the operations such as cleaning the lid based on the color change of the thermochromic coating, providing a better user experience. It needs to be noted that a specific type of this cooking appliance is not particularly limited, and may be flexibly selected by those skilled in the art as actual needs. For example, this cooking appliance may include, but is not limited to, a cooking device such as a rice cooker, a cooking machine, or a pressure cooker. According to a specific example of the present disclosure, the cooking appliance may also include a base, an inner pot, and a lid. The base may be provided with an accommodation section for accommodating the inner pot. A region of a lower part of the base corresponding to the inner pot may be provided with a heating member such as a coil plate. The lid is movably connected to an upper part of the base and may cover the inner pot. The lid may include the pot lid assembly as described above. In addition, connection manners between the base, the inner pot, and the lid may be the same as those of existing cooking appliances, and details are omitted herein. In addition, it also needs to be noted that the features and effects described for the above-mentioned pot lid assembly also apply to this cooking appliance, and details are omitted herein.

In the description of this specification, descriptions with reference to the terms “an embodiment,” “some embodiments,” “examples,” “specific examples,” or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

Although the embodiments of the present disclosure have been shown and described above, it would be appreciated by those skilled in the art that the above embodiments are exemplary and cannot be construed as limiting the present disclosure, and changes, modifications, substitutions, and variations can be made by those skilled in the art to the above embodiments within the scope of the present disclosure.

1.-24. (canceled)

25. A pot lid assembly comprising:
an inner lid having a mounting space;
a coil assembly fixed in the mounting space and including a coil winding;
a thermal insulation base plate disposed on the inner lid and located below the coil assembly;
a thermochromic coating disposed on a surface of the thermal insulation base plate and configured to change color subsequent to a temperature of the thermochromic coating reaching a color changing temperature; and
a thermal insulation cover plate disposed at a side of the inner lid facing towards a pot and located below the thermal insulation base plate, the thermal insulation cover plate being heated when the coil winding is energized.

26. The pot lid assembly according to claim 25, wherein:
the coil assembly is configured to heat the thermal insulation cover plate by generating an eddy current that passes through the thermal insulation base plate; and/or
the thermal insulation cover plate includes a metal plate configured to generate heat by cutting through the eddy current generated by the coil winding when the coil winding is energized.

27. The pot lid assembly according to claim 26, wherein the thermal insulation cover plate further includes a connection member, the metal plate being detachably connected to the inner lid through the connection member.

28. The pot lid assembly according to claim 25, wherein a surface of the thermochromic coating is covered with a hydrophobic layer made of a transparent material.

29. The pot lid assembly according to claim 28, wherein a thickness of the hydrophobic layer is smaller than or equal to 0.1 mm.

30. The pot lid assembly according to claim 25, further comprising:
a surface coating disposed on the thermal insulation base plate and located at a side of the thermochromic coating away from the pot.

31. The pot lid assembly according to claim 30, wherein:
the thermal insulation base plate includes a transparent base plate, the thermochromic coating being disposed on a surface of the thermal insulation base plate away from the pot, and the surface coating being disposed on a surface of the thermochromic coating away from the pot; and/or
a thickness of the surface coating is smaller than or equal to 0.1 mm.

32. The pot lid assembly according to claim 31, wherein:
the surface coating includes a wear-resistant and scratch-resistant coating; and/or
a side of the surface coating away from the pot is covered with a hydrophobic layer.

33. The pot lid assembly according to claim 32, wherein a thickness of the hydrophobic layer is smaller than or equal to 0.1 mm.

34. The pot lid assembly according to claim 25, wherein a color saturation of the thermochromic coating changes reversibly with a temperature change.

35. The pot lid assembly according to claim 25, wherein at least part of the thermochromic coating is a reversible color changing region, the reversible color changing region being a temperature-sensitive color-developing region, a temperature-sensitive color-disappearing region, or an interval temperature-sensitive color-developing region.

36. The pot lid assembly according to claim 25, wherein:
the thermochromic coating includes a plurality of color changing sub-coatings that are arranged at intervals or continuously, color changing temperatures of the plurality of color changing sub-coatings being same or different; and/or
the thermochromic coating includes thermochromic ink.

37. The pot lid assembly according to claim 25, wherein:
the color changing temperature of the thermochromic coating ranges from 5 °C to 80 °C; and/or
a thickness of the thermochromic coating is smaller than or equal to 0.1 mm.

38. The pot lid assembly according to claim 25, wherein a region of the thermal insulation base plate in direct contact with the thermochromic coating is a rough surface, the rough surface being formed by roughening the surface of the thermal insulation base plate.

39. The pot lid assembly according to claim 38, wherein roughness of the rough surface is greater than or equal to 0.1 μm.

40. The pot lid assembly according to claim 25, wherein:
the thermal insulation base plate is an inorganic glass base plate, a microcrystalline glass base plate, or a transparent resin base plate;
a thickness of the thermal insulation base plate ranges from 2 mm to 5 mm; and/or
in a thickness direction of the inner lid, a distance between the thermal insulation base plate and the coil winding ranges from 5 mm to 30 mm, and a distance between the thermal insulation base plate and the thermal insulation cover plate ranges from 5 mm to 30 mm.

41. The pot lid assembly according to claim 25, further comprising:
a steam valve disposed on the inner lid and located at a side of the mounting space;
wherein:
the thermal insulation base plate is disposed in the mounting space and located close to the steam valve;
an enclosed space is formed by the coil assembly, the thermal insulation cover plate, and the steam valve, the thermal insulation base plate being disposed in the enclosed space;
a distance between the thermal insulation base plate and the thermal insulation cover plate is smaller than or equal to a distance between the thermal insulation base plate and the coil winding; and/or
the thermal insulation base plate is brown.

42. The pot lid assembly according to claim 41, wherein the mounting space has a first inner wall formed into an arc shape and a second inner wall formed as a flat surface, the second inner wall being connected to both ends of the first inner wall, the second inner wall being disposed adjacent to the steam valve, and an outer peripheral wall of the coil assembly being adapted to a shape of the mounting space.

43. The pot lid assembly according to claim 25, wherein a surface of the thermal insulation cover plate facing towards the pot has a concave-convex pattern, an orthogonal projection of the coil winding on the thermal insulation cover plate covering the concave-convex pattern.

44. A cooking appliance comprising a pot lid assembly including:
an inner lid having a mounting space;
a coil assembly fixed in the mounting space and including a coil winding;
a thermal insulation base plate disposed on the inner lid and located below the coil assembly;
a thermochromic coating disposed on a surface of the thermal insulation base plate and configured to change color subsequent to a temperature of the thermochromic coating reaching a color changing temperature; and
a thermal insulation cover plate disposed at a side of the inner lid facing towards a pot and located below the thermal insulation base plate, the thermal insulation cover plate being heated when the coil winding is energized.
